(19) United States
(12) Patent Application Publication
(10) Pub. No.: US 2022/0066398 A1
(43) Pub. Date: Mar. 3, 2022

(54) CONTROL DEVICE FOR ELECTRONIC DEVICE, CONTROL METHOD, STORAGE MEDIUM, TIMEPIECE, TIMEPIECE MAIN BODY AND BAND

(71) Applicant: Casio Computer Co., Ltd., Tokyo (JP)

(72) Inventors: Takeshi OKADA, Tokyo (JP); Masaru SAKATA, Tokyo (JP); Yuuichi SAGOU, Tokyo (JP); Kousuke ISHIZAKI, Tokyo (JP); Toshiaki MAEBARA, Yokohama-shi (JP); Masaki TAKANASHI, Tokyo (JP)

(21) Appl. No.: 17/459,643

(22) Filed: Aug. 27, 2021

(30) Foreign Application Priority Data
Aug. 31, 2020 (JP) 2020-145476
Jul. 15, 2021 (JP) 2021-117143

(51) Int. Cl. G04G 21/02; A44C 5/14; G01P 15/18; G04G 9/00; G04B 45/00

(52) U.S. Cl. CPC G04G 21/025; A44C 5/14; G04B 45/0076; G04G 9/0064; G01P 15/18

(57) ABSTRACT

At least one processor that identifies which of a plurality of exterior bodies individually formed in advance is an exterior body attached to a main body of an electronic device capable of executing at least a first function and a second function which are not display functions and are different from each other, enables at least the first function of the electronic device and disables at least the second function of the electronic device when the identified exterior body is a certain exterior body among the plurality of exterior bodies, and enables at least the second function of the electronic device and disables at least the first function of the electronic device when the identified exterior body is another exterior body different from the certain exterior body among the plurality of exterior bodies.

### CROSS-REFERENCE TO RELATED APPLICATIONS

This application is based upon and claims the benefit of priority from the prior Japanese Patent Applications No. 2020-145476, filed Aug. 31, 2020, and No. 2021-117143, filed Jul. 15, 2021, the entire contents of which are incorporated herein by reference.

### BACKGROUND OF THE INVENTION

### 1. Field of the Invention

The present invention relates to a control device for an electronic device, a control method, a storage medium, a timepiece, a timepiece main body, and a band.

### 2. Description of the Related Art

Conventionally, a wristwatch type electronic device has been disclosed in, for example, Japanese Patent Application Laid-Open (Kokai) Publication No. 2017-167088. This electronic device has a structure where watchbands that are different from one another in design and serve as exterior bodies are each attachable to a main body section having a display device, a band attached to the main body section is identified, and display contents corresponding to the attached band are displayed on the display device so as to enhance the attractiveness.

### SUMMARY OF THE INVENTION

In accordance with one aspect of the present invention, there is provided a control device of an electronic device comprising: at least one processor which executes a program stored in at least one memory, wherein the at least one processor identifies which of a plurality of exterior bodies individually formed in advance is an exterior body attached to a main body of the electronic device capable of executing at least a first function and a second function which are not display functions and are different from each other, and wherein the at least one processor enables at least the first function of the electronic device and disables at least the second function of the electronic device when the identified exterior body is a certain exterior body among the plurality of exterior bodies, and enables at least the second function of the electronic device and disables at least the first function of the electronic device when the identified exterior body is another exterior body different from the certain exterior body among the plurality of exterior bodies.

In accordance with another aspect of the present invention, there is provided a control method for an electronic device, comprising: identifying which of a plurality of exterior bodies individually formed in advance is an exterior body attached to a main body of the electronic device capable of executing at least a first function and a second function which are not display functions and are different from each other; and enabling at least the first function of the electronic device and disabling at least the second function of the electronic device when the identified exterior body is a certain exterior body among the plurality of exterior bodies, and enabling at least the second function of the electronic device and disabling at least the first function of the electronic device when the identified exterior body is another exterior body different from the certain exterior body among the plurality of exterior bodies.

In accordance with another aspect of the present invention, there is provided a non-transitory computer-readable storage medium having stored thereon a control program that is executable by a computer to actualize functions comprising: identifying which of a plurality of exterior bodies individually formed in advance is an exterior body attached to a main body of an electronic device capable of executing at least a first function and a second function which are not display functions and are different from each other; and enabling at least the first function of the electronic device and disabling at least the second function of the electronic device when the identified exterior body is a certain exterior body among the plurality of exterior bodies, and enabling at least the second function of the electronic device and disabling at least the first function of the electronic device when the identified exterior body is another exterior body different from the certain exterior body among the plurality of exterior bodies.

In accordance with another aspect of the present invention, there is provided a timepiece comprising: a timepiece main body which is capable of executing at least a first function and a second function which are not display functions and are different from each other; a band which is attached to the timepiece main body; and at least one processor which executes a program stored in at least one memory, wherein the at least one processor identifies which of a plurality of bands individually formed in advance is the band attached to the timepiece main body, and wherein the at least one processor enables at least the first function of the timepiece main body and disables at least the second function of the timepiece main body when the identified band is a certain band among the plurality of bands, and enables at least the second function of the timepiece main body and disables at least the first function of the timepiece main body when the identified band is another band different from the certain band among the plurality of bands.

In accordance with another aspect of the present invention, there is provided a timepiece main body which is capable of executing at least a first function and a second function which are not display functions and are different from each other and to which a band is attached, comprising: at least one processor which executes a program stored in at least one memory, wherein the at least one processor identifies which of a plurality of bands individually formed in advance is the band attached to the timepiece main body, and wherein the at least one processor enables at least the first function of the timepiece main body and disables at least the second function of the timepiece main body when the identified band is a certain band among the plurality of bands, and enables at least the second function of the timepiece main body and disables at least the first function of the timepiece main body when the identified band is another band different from the certain band among the plurality of bands.

In accordance with another aspect of the present invention, there is provided a band that is attached to the timepiece main body described above, comprising: a wireless tag which provides the timepiece main body with identification information that is used for identification of the band.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a schematic diagram showing an electronic device according to an embodiment of the present invention;

FIG. 2 is a block diagram outlining the electrical structure of the electronic device;

FIG. 3 is a flowchart showing details of processing by a CPU (Central Processing Unit) of the electronic device;

FIG. 4 is a flowchart following that of FIG. 3;

FIG. 5 is also a flowchart following that of FIG. 3;

FIG. 6A to FIG. 6C are diagrams showing screen transitions of a display section when bands for a running exercise are attached;

FIG. 7A to FIG. 7C are diagrams showing screen transitions of the display section when bands for a cycling exercise are attached;

FIG. 8A to FIG. 8C are diagrams showing screen transitions of the display section when bands for business use are attached;

FIG. 9A to FIG. 9C are diagrams showing screen transitions of the display section when bands that are worn during a sleeping period are attached; and

FIG. 10 is a diagram showing the initial screen of the display section when bands for a different purpose are attached.

### DETAILED DESCRIPTION OF THE PREFERRED EMBODIMENT

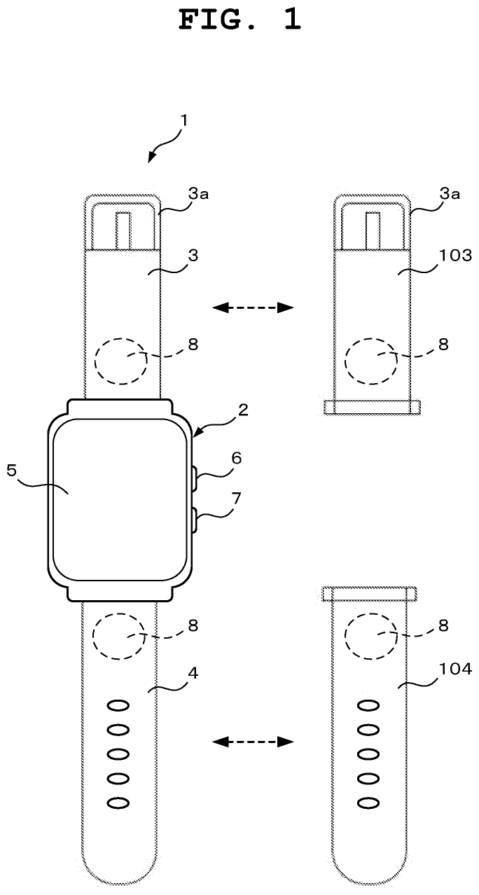

An embodiment of the present invention will hereinafter be described. FIG. 1 is a schematic diagram showing an electronic device 1 according to an embodiment of the present invention. This electronic device 1 of the present embodiment is a wristwatch type device (such as a smartwatch), and includes a device main body 2 corresponding to a timepiece main body, a first band 3 having a buckle 3a attached to the device main body 2, and a second band 4 to be connected to the first band 3 via the buckle 3a, as shown in FIG. 1.

The device main body 2 is provided with a display section 5 and operation switches 6 and 7. The display section 5 displays, for example, timepiece face information including time information and various types of information described later as display contents. The operation switch 6 is used for power ON/OFF of the electronic device 1, switching of operation modes, or the like. Also, the other operation switch 7 is used for settings related to the functions of the electronic device 1, changes in display contents of the display section 5, ON/OFF operations related to display, or the like.

The first band 3 and the second band 4 are respectively attached to the device main body 2 via an interchange mechanism (such as a habiller-type spring bar with a lever). By a user wearing the electronic device 1, these first and second bands 3 and 4 can be switched to other first and second bands 3 and 4 (103 and 104 in FIG. 1) which may be different in design, color, material, or the like and are individually provided in advance according to the user's fashion or intended use. Note that the attachment structures of the first band 3 and the second band 4 are not limited thereto. For example, a structure may be adopted in which, on the device main body 2, attachment sections are provided which disengageably lock the first band 3 and the second band 4 and release their locked state by buttons, levers, or the like provided thereon.

Also, the first band 3 and the second band 4 are provided with wireless tags 8. The wireless tags 8 in this embodiment are tags for performing wireless communication based on NFC (Near Field Communication) standards, and are structured to be embedded in the first band 3 and the second band 4 so as not to be seen from outside. Note that these wireless tags 8 are only required to be integrally provided in the first band 3 and the second band 4. Accordingly, for example, a structure may be adopted in which the wireless tags 8 are fitted into or adhered to the surfaces of the first band 3 and the second band 4 such that they can be seen from outside. Each wireless tag 8, into which a memory having identification information and an antenna are built, receives power supply from the electronic device 1 via electric waves, operates by the electric power, and thereby transmits the identification information to the electronic device 1. Note that the actual structures, shapes, and positions of the wireless tags 8 may be arbitrarily determined. The above-described identification information includes an intended use number indicating the type of intended use of the first band 3 or the second band 4. In this embodiment, the intended uses of the first and second bands 3 and 4 are “running”, “cycling”, “business” or “sleep”. Note that the “running” herein is an exercise in which the user himself or herself runs, such as jogging or trail running. However, it may be other exercises that can be performed instead of or together with the running exercise, such as a walking (ambulation) exercise, swimming, yoga, and other fitness exercises.

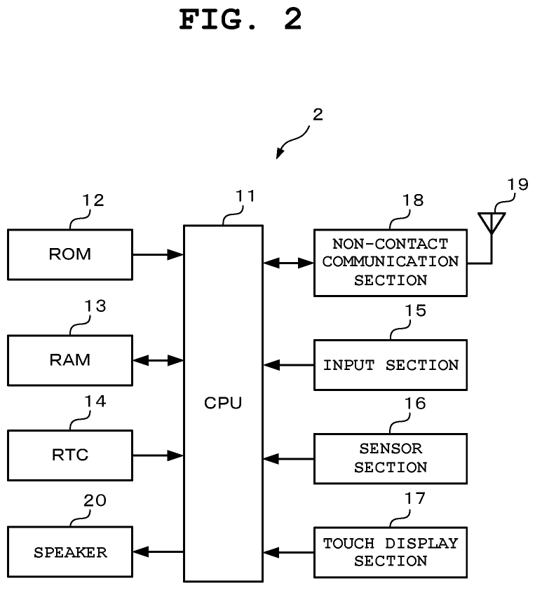

FIG. 2 is a block diagram outlining the electrical structure of the device main body 2. This device main body 2 includes at least one CPU (Central Processing Unit) 11 as at least one processor, at least one ROM (Read Only Memory) 12 as at least one memory, a RAM (Random Access Memory) 13, an RTC (Real Time Clock) 14, an input section 15, a sensor section 16, a touch display section 17, a non-contact communication section 18, and a speaker 20, as shown in FIG. 2.

The CPU 11 controls all the sections in the device main body 2 in accordance with programs stored in the ROM 12. The ROM 12 is a non-volatile memory whose memory contents are rewritable. The RAM 13 is a working memory in which the CPU 11 temporarily stores various data as necessary. The RTC 14, which is to clock the current time and has a calendar function, supplies current date information and time information to the CPU 11. The sensor section 16 is constituted by various sensors such as an acceleration sensor, a heartbeat sensor (photoelectric pulse wave sensor), an earth magnetism sensor, a gyro sensor, an air pressure sensor, or the like, and supplies detection results of the various sensors to the CPU 11.

The various sensors herein also includes a GPS (Global Positioning System) sensor which receives a GPS satellite signal transmitted from a GPS satellite and acquires positioning information including the position, altitude and speed of the electronic device 1 represented by longitude, latitude and altitude, and the sensor section 16 also supplies this positioning information acquired by the GPS sensor to the CPU 11. Note that the GPS sensor is not necessarily required to be a sensor using the GPS and may be a sensor using another satellite positioning system such as QZSS (Quasi-Zenith Satellite System), GLONASS (Global Navigation Satellite System), Galileo, Beidou (BeiDou Navigation Satellite System), or the like as long as the above-described positioning information can be acquired. The ROM 12 has stored therein setting information regarding various functions of the electronic device 1 set by the user and various types of information acquired by the electronic device 1 in addition to the above-described programs.

The input section 15 is constituted by the operation switches 6 and 7, and operation statuses of these operation switches 6 and 7 are sequentially detected by the CPU 11. The touch display section 17 constitutes the display section 5 of the device main body 2. More specifically, the touch display section 17 has a structure where a touch panel has been laminated on a display such as a LCD (Liquid Crystal Display). In accordance with control by the CPU 11, this touch display section 17 displays timepiece face information which is constituted by various types of information and provided to the user, in a predetermined format. Also, this touch display section 17 detects the user's touch operation on the display section 5, and supplies this information to the CPU 11 as operation information.

The non-contact communication section 18 performs wireless communication based on NFC standards with the wireless tags 8 provided in the first band 3 and the second band 4 via an antenna 19, reads out identification information from both of the wireless tags 8 individually, and supplies them to the CPU 11. In order to achieve this configuration, the antenna 19 is provided inside the device main body 2 in a manner that its structure and position enable communication with both of the wireless tags 8 individually. Note that a structure may be adopted in which an antenna 19 for communication with the wireless tag 8 on the first band 3 side and an antenna 19 for communication with the wireless tag 8 on the second band 4 side are individually provided.

On the other hand, the electronic device 1 has, as functions executable by the CPU 11 operating based on programs stored in the ROM 12, a plurality of functions which corresponds to a plurality of intended uses of the user of the electronic device 1 and includes a first function to a fourth function.

Here, the first function, which is useful for a running exercise, includes a function for acquiring the positioning information of the electronic device 1 by the GPS sensor of the sensor section 16. The second function, which supports the sleep of the user and acquires the sleeping condition of the user, includes a function for detecting acceleration by the acceleration sensor and detecting heartbeat (pulse) by the heartbeat sensor of the sensor section 16. The third function, which is useful for a cycling exercise, includes a function for acquiring the positioning information of the electronic device 1 by the GPS sensor of the sensor section 16, as with the first function. The fourth function, which is useful for business, includes a function for detecting heartbeat (pulse) by the heartbeat sensor of the sensor section 16. Details of each function will be described later.

By setting an intended operation mode from among a plurality of operation modes provided for the electronic device 1, the user can selectively use one of the above-described first to fourth functions. In this embodiment, the user can use the first function by setting a running exercise mode as the current operation mode, and can use the second function by setting a sleep time mode as the current operation mode. Also, the user can use the third function by setting a cycling exercise mode as the current operation mode, and can use the fourth function by setting a business mode as the current operation mode. Note that operation mode setting by the user is performed by, for example, tap operations or flick operations on the display section 5.

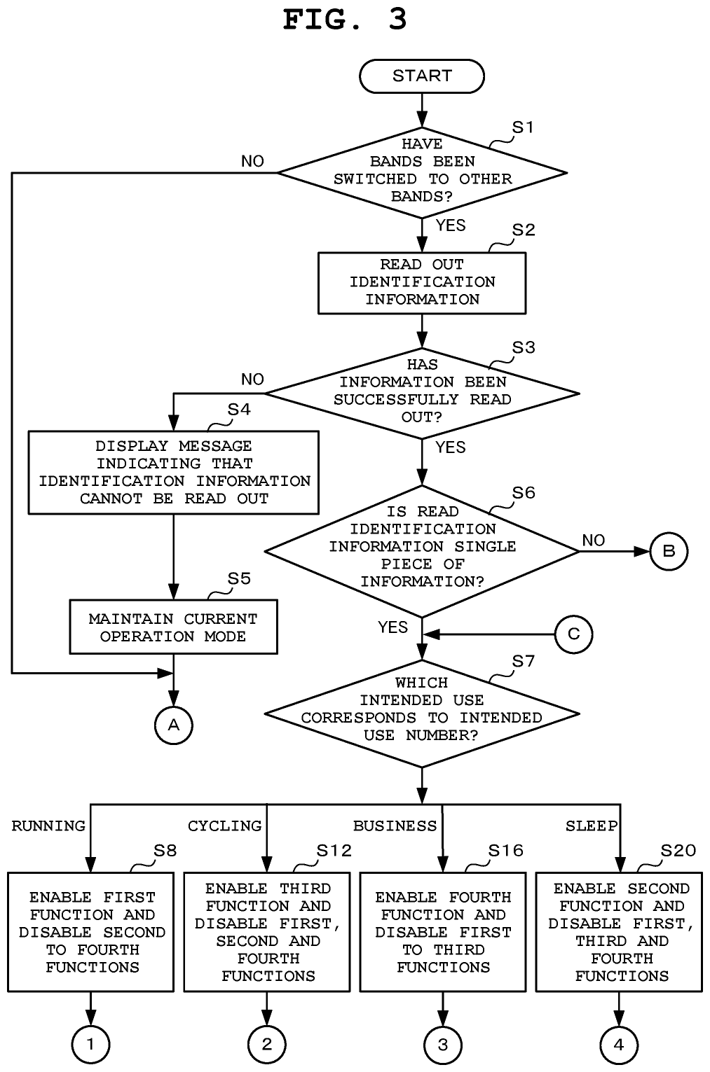

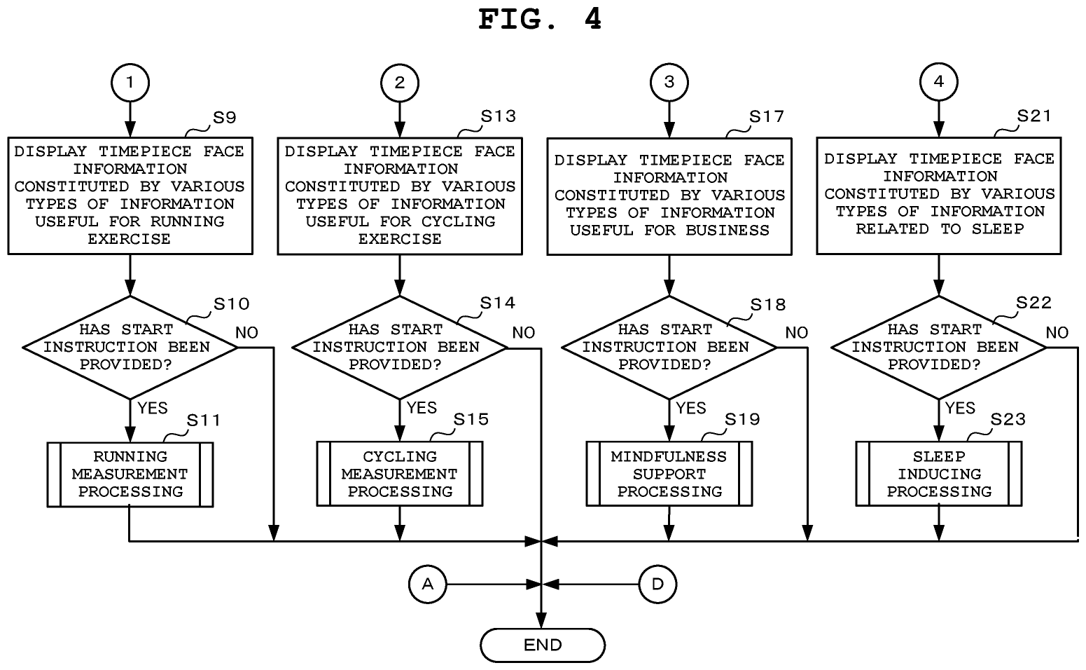

Next, operations of the electronic device 1 according to the present invention are described. FIG. 3 to FIG. 5 are flowcharts showing details of processing by the CPU 11 in the device main body 2, which are repeatedly performed by the CPU 11 at operation timings in predetermined cycles. More specifically, these flowcharts mainly show processing to be performed by the CPU 11 when the first band 3 and the second band 4 are switched to other bands.

When an operation is started at certain timing described above, the CPU 11 first judges whether the first band 3 and the second band 4 have been switched to other bands (Step S1). This judgment is performed by, for example, the acceleration sensor provided in the device main body 2. More specifically, a large amount of transition data related to the acceleration of the device main body 2 when its bands are being switched to other bands and those when no band is being switched are acquired in advance, and a discriminator (such as Support Vector Machine, Neural Network, or the like) is generated by supervised machine learning using the acquired acceleration transition data. Here, the machine learning of the discriminator is performed so as to enable discrimination as to whether inputted transition data related to the acceleration of the device main body 2 is equivalent to acceleration transition data acquired when its bands are being switched to other bands. Thus, in the processing at Step S1, whether the first band 3 and the second band 4 have been switched to other bands is judged based on a discrimination result generated by acceleration transition data acquired at Step S1 being inputted into the above-described discriminator.

When judged that the first band 3 and the second band 4 have not been switched to other bands (NO at Step S1), the CPU 11 immediately ends the processing. Conversely, when judged that the first band 3 and the second band 4 have been switched to other bands (YES at Step S1), the CPU 11 activates the non-contact communication section 18 and reads out identification information from the current wireless tags 8 (Step S2). Here, when no identification information can be read out (NO at Step S3), the CPU 11 displays, on the display section 5, a message or the like indicating that no identification information can be read out (Step S4). Note that this case where no identification information can be read out includes a case where bands that do not have wireless tags 8 have been attached to the electronic device 1. Then, the CPU 11 ends the processing while maintaining the current operation mode (Step S5).

On the other hand, when identification information is read out (YES at Step S3) and this identification information is judged to be a single piece of information (YES at Step S6), the CPU 11 identifies an intended use corresponding to an intended use number included in the read identification information (Step S7). That is, in this embodiment, the CPU 11 judges which of “running”, “cycling”, “business”, and “sleep” is the intended use of the currently attached first and second bands 3 and 4. Then, the CPU 11 performs the later-described processing of Steps S8 to S23 in accordance with the identified intended use.

First, in the case where the identified intended use is “running”, the CPU 11 enables the first function and disables the second to fourth functions among the above-described plurality of functions of the electronic device 1 (Step S8). Note that disabling the functions herein refers to the device entering a state where the user cannot use these functions. That is, as the current operation mode, the running exercise mode in which the first function is used is forcibly set (fixed) at this point. Simultaneously, the device enters a state in which, even if a normal mode selection operation is performed by tap operations or flick operations on the display section 5, the other operation modes cannot be selected. Also, since the first function includes the acquisition of the positioning information of the electronic device 1 as described above, the CPU 11 starts measuring the position of the electronic device 1 at this point by the GPS sensor of the sensor section 16. Then, the CPU 11 displays, on the display section 5, an information group based on the enabled function, that is, timepiece face information constituted by various types of information useful for a running exercise (Step S9). Note that, although not shown in the drawings, the above-described processing at Step S8 and Step S9 is skipped in a situation where the mode for using the first function has already been set as the current operation mode, that is, a situation where the running exercise mode had already been set by the user before the first band 3 and the second band 4 have been switched to other bands.

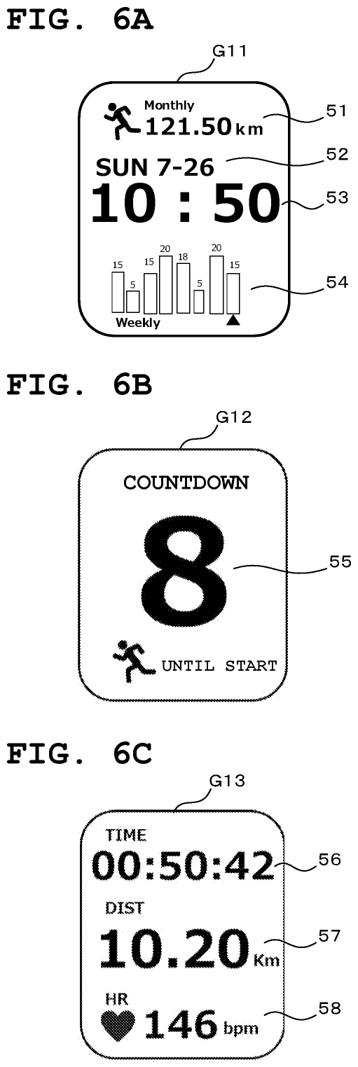

FIG. 6A is a diagram exemplarily showing timepiece face information in this case on an initial screen G11 displayed on the display section 5 in response to the processing of Step S9. On this initial screen G11, timepiece face information is displayed in a predetermined format, which is constituted by various types of information such as monthly distance information 51 indicating a running distance from the beginning of a month to a current time point, calendar information 52 indicating a date and a day of the week such that they are horizontally displayed, time information 53 digitally indicating the current time, and weekly distance information 54 indicating running distances in recent weeks.

Then, the CPU 11 judges whether an operation start instruction has been provided from the user (Step S10). This start instruction in the present embodiment is performed by one operation determined in advance, such as a tap operation or a flick operation on the display section 5. When judged that no start instruction has been provided (NO at Step S10), the CPU 11 ends the processing at this point. In this case, the state where the first function has been enabled and the second to fourth functions have been disabled is maintained. In addition, the display of the initial screen G11 is maintained. Conversely, when judged that a start instruction has been provided during the display of the initial screen G11 (YES at Step S10), the CPU 11 immediately starts running measurement processing (Step S11).

This running measurement processing, which achieves the first function together with the display processing of the timepiece face information at Step S9, is processing regarding a function of acquiring (deriving) and storing information related to the user's heart rate, running distance, running speed, consumed calorie, lap time, elapsed time from a running start time, average stride, pitch, running route, and the like during a running exercise based on detection results from the above-described various sensors in the sensor section 16, and sequentially providing part of the information to the user. Here, the user's heart rate, running distance, running speed, consumed calorie, lap time, elapsed time from the running start time, average stride, and pitch correspond to the user's exercise information during the running exercise. The method of deriving these various types of information is well known and therefore details thereof are omitted.

In the running measurement processing, the CPU 11 controls the display screen of the display section 5 such that the initial screen G11 is switched to a start screen G12 shown in FIG. 6B. This start screen G12 is to notify the user of timing to start a running exercise. Here, the CPU 11 performs a countdown of the time remaining until the start in units of seconds, and displays remaining time information 55 on the screen. Then, when the running start timing comes, the CPU 11 controls the display screen of the display section 5 such that the start screen G12 is switched to a measurement screen G13 shown in FIG. 6C and thereby displays, on the screen of the display section 5, time information 56 indicating the time elapsed from the start of the running exercise, distance information 57 indicating the running distance, and heartbeat information 58 indicating the heart rate. Then, the CPU 11 ends the processing started immediately after the first band 3 and the second band 4 are switched to other bands.

At Step S7, when the intended use identified in the processing is “cycling”, the CPU 11 enables the third function and disables the first, second, and fourth functions among the above-described plurality of functions of the electronic device (Step S12). In this case as well, disabling the functions refers to the device entering a state where the user cannot use these functions. Accordingly, as the current operation mode, the cycling exercise mode in which the third function is used is forcibly set (fixed) at this point. Simultaneously, the device enters the state in which, even if a normal mode selection operation is performed by tap operations or flick operations on the display section 5, the other operation modes cannot be selected. Also, since the third function includes the acquisition of the positioning information of the electronic device 1 by the GPS sensor of the sensor section 16 as in the case of the first function, the CPU 11 starts measuring the position of the electronic device 1 at this point by the GPS sensor of the sensor section 16. Then, the CPU 11 displays, on the display section 5, an information group based on the enabled function, that is, timepiece face information constituted by various types of information useful for a cycling exercise (Step S13). Note that, although not shown in the drawings, the above-described processing at Step S12 and Step S13 is skipped in a situation where the mode for using the third function has already been set as the current operation mode, that is, a situation where the cycling exercise mode had already been set by the user before the first band 3 and the second band 4 have been switched to other bands.

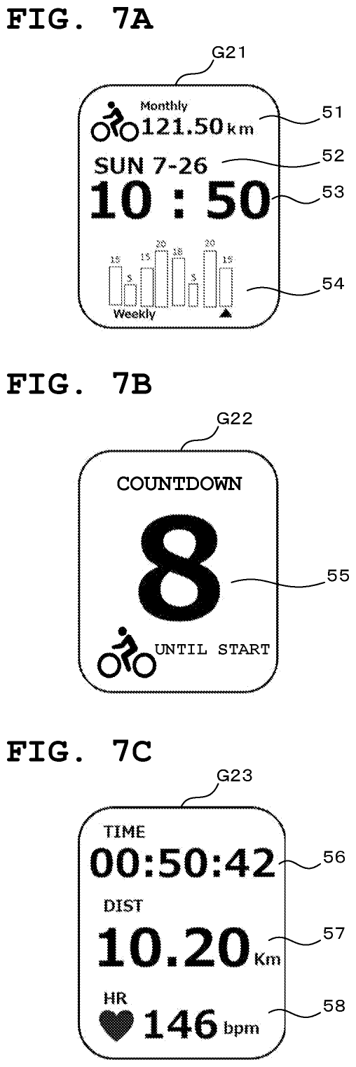

FIG. 7A is a diagram exemplarily showing timepiece face information in this case on an initial screen G21 displayed on the display section 5 in response to the processing of Step S13. This initial screen G21 is basically the same as the initial screen G11 shown in FIG. 6A except that the monthly distance information 51 and the weekly distance information 54 displayed on this initial screen G21 indicate traveling distances in cycling exercises.

Then, the CPU 11 judges whether an operation start instruction has been provided from the user and, if no instruction has been provided (NO at Step S14), ends the processing at this point. In this case, the state where the third function has been enabled and the first, second, and fourth functions have been disabled is maintained. In addition, the display of the initial screen G21 is maintained. Conversely, when judged that a start instruction has been provided during the display of the initial screen G21 (YES at Step S14), the CPU 11 immediately starts cycling measurement processing (Step S15).

This cycling measurement processing, which achieves the third function together with the display processing of the timepiece face information at Step S13, is processing regarding a function of acquiring (deriving) and storing information which is substantially the same as that in the above-described running measurement processing, and sequentially providing part of the information to the user. In this case, these pieces of information (the user's heart rate, traveling distance, traveling speed, consumed calorie, lap time, and elapsed time from a cycling start time) correspond to the exercise information of the user riding a bicycle. Note that, unlike the running measurement processing, the CPU 11 in this processing acquires (derives) and stores information regarding a road grade at each point on a traveling route instead of the user's average stride and pitch. The deriving method in this case is also well known and therefore details thereof are omitted.

In the cycling measurement processing, the CPU 11 controls the display screen of the display section 5 such that the initial screen G21 is switched to a start screen G22 shown in FIG. 7B, and thereby displays the remaining time information 55 on the screen so as to perform a countdown of the time remaining until the start. Then, when the cycling start timing comes, the CPU 11 controls the display screen of the display section 5 such that the start screen G22 is switched to a measurement screen G23 shown in FIG. 7C, and thereby displays various types of information on the screen of the display section 5. Then, the CPU 11 ends the processing started immediately after the first band 3 and the second band 4 are switched to other bands.

At Step S7, when the intended use identified in the processing is “business”, the CPU 11 enables the fourth function and disables the first, second, and third functions among the above-described plurality of functions of the electronic device (Step S16). In this case as well, disabling the functions refers to the device entering a state where the user cannot use these functions. Accordingly, as the current operation mode, the business mode in which the fourth function is used is forcibly set (fixed) at this point. Simultaneously, the device enters the state in which, even if a normal mode selection operation is performed by tap operations or flick operations on the display section 5, the other operation modes cannot be selected. Then, the CPU 11 displays, on the display section 5, an information group based on the enabled function, that is, timepiece face information constituted by various types of information useful for business (Step S17). Note that, although not shown in the drawings, the above-described processing at Step S16 and Step S17 is skipped in a situation where the mode for using the fourth function has already been set as the current operation mode, that is, a situation where the business mode had already been set by the user before the first band 3 and the second band 4 have been switched to other bands.

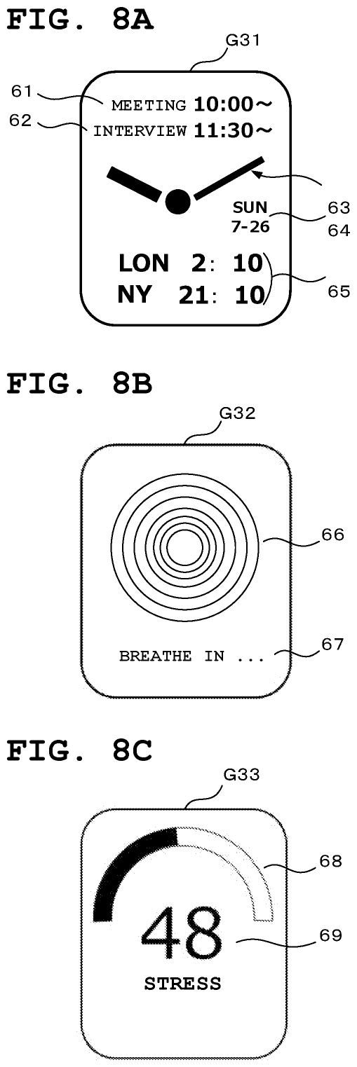

FIG. 8A is a diagram exemplarily showing timepiece face information in this case on an initial screen G31 displayed on the display section 5 in response to the processing of Step S17. On this initial screen G31, timepiece face information is displayed in a predetermined format, which is constituted by various types of information such as time information 61 indicating the starting time of a scheduled meeting, time information 62 indicating the starting time of a scheduled interview, time information 63 indicating the current time by an hour pointer and a minute pointer, calendar information 64 indicating a date and a day of the week such that they are vertically displayed, and world time information 65 indicating the current time of two cities set in advance. Here, the time information 61 and 62 indicating the starting time of a meeting and that of an interview is part of task schedule information included in various types of user task information inputted in advance in the electronic device 1 by the user and stored in the ROM 12.

Then, as with the other cases described above, the CPU 11 judges whether an operation start instruction has been provided and, if no instruction has been provided (NO at Step S18), ends the processing at this point. In this case, the state where the fourth function has been enabled and the first to third functions have been disabled is maintained. In addition, the display of the initial screen G31 is maintained. Conversely, when judged that a start instruction has been provided during the display of the initial screen G31 (YES at Step S18), the CPU 11 immediately starts mindfulness support processing (Step S19).

This mindfulness support processing, which achieves the fourth function together with the display processing of the timepiece face information at Step S17, is processing for supporting the user performing mindfulness meditation which is expected to improve work performance. In this mindfulness support processing, the CPU 11 first controls the display screen of the display section 5 such that the initial screen G31 is switched to a start screen G32 shown in FIG. 8B, and starts heartbeat detection by the heartbeat (pulse) sensor of the sensor section 16. Here, the CPU 11 displays on the screen an object (still image or moving image) 66 associated with meditation, and sequentially displays captions 67 explaining a meditation procedure.

Then, after a predetermined amount of time, the CPU 11 ends the heartbeat detection and calculates a stress index (LF/HF) which is publicly known and indicates the stress of the user based on changes in heartbeat intervals within the predetermined amount of time. Subsequently, the CPU 11 controls the display screen of the display section 5 such that the start screen G32 is switched to a measurement result screen G33 shown in FIG. 8C, and thereby displays on the screen a result of the stress index calculation, that is, a gauge 68 and numerical value information 69 indicating the current stress condition, as information indicating the effect of the meditation. Then, the CPU 11 ends the processing started immediately after the first band 3 and the second band 4 are switched to other bands. Note that a configuration may be adopted in which the CPU 11 judges whether or not the stress index has been calculated during work on the basis of the user's schedule information and, when judged that it has been calculated during work, the stress index is outputted as a stress index for the task (task information).

At Step S7, when the intended use identified in the processing is “sleep”, the CPU 11 enables the second function and disables the first, third, and fourth functions among the above-described plurality of functions of the electronic device 1 (Step S20). In this case as well, disabling the functions refers to the device entering a state where the user cannot use these functions. Accordingly, as the current operation mode, the sleep time mode in which the second function is used is forcibly set (fixed) at this point. Simultaneously, the device enters the state in which, even if a normal mode selection operation is performed by tap operations or flick operations on the display section 5, the other operation modes cannot be selected. Then, the CPU 11 displays, on the display section 5, an information group based on the enabled function, that is, timepiece face information constituted by various types of information related to sleep (Step S21). Note that, although not shown in the drawings, the above-described processing at Step S20 and Step S21 is skipped in a situation where the mode for using the second function has already been set as the current operation mode, that is, a situation where the sleep time mode had already been set by the user before the first band 3 and the second band 4 have been switched to other bands.

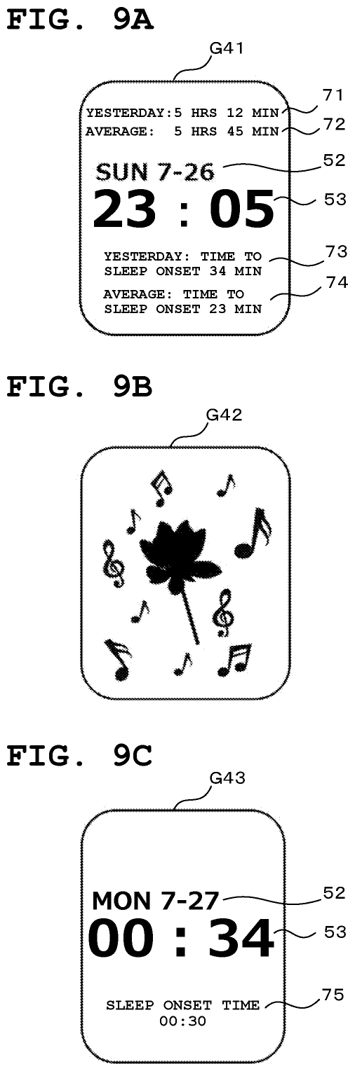

FIG. 9A is a diagram exemplarily showing timepiece face information in this case, or more specifically, a diagram showing an initial screen G41 that is displayed on the display section 5 by the processing of Step S21. On this initial screen G41, timepiece face information is displayed in a predetermined format, which is constituted by various types of information such as sleeping hours information 71 indicating the amount of time spent sleeping yesterday, average sleeping hours information 72 indicating the average time spent sleeping in the last week, the calendar information 52 indicating a date and a day of the week such that they are horizontally displayed, the time information 53 digitally indicating the current time, sleep onset period information 73 indicating the time to sleep onset measured yesterday, and average sleep onset period information 74 indicating the average time to sleep onset for the last week. Although not shown in the drawings, in a case where display items on the initial screen G41 have been changed in advance by the user, sleeping condition distribution information indicating the distribution of REM sleep states and non-REM sleep states measured yesterday during the sleeping hours is displayed on the initial screen G41 instead of the sleep onset period information 73 and the average sleep onset period information 74.

Then, as with the other cases described above, the CPU 11 waits until a start instruction is provided and, if no instruction is provided (NO at Step S22), ends the processing at this point. In this case, the state where the second function has been enabled and the first, third, and fourth functions have been disabled is maintained. In addition, the display of the initial screen G41 is maintained. Conversely, when judged that a start instruction has been provided during the display of the initial screen G41 (YES at Step S22), the CPU 11 immediately starts sleep inducing processing (Step S23).

This sleep inducing processing, which achieves the second function together with the display processing of the timepiece face information at Step S21, is processing regarding a function of supporting the sleep of the user. In this sleep inducing processing, the CPU 11 controls the display screen of the display section 5 such that the initial screen G41 is switched to a music playback screen G42 shown in FIG. 9B, and starts the playback of sleep inducing music that produces a relaxing effect based on music data stored in the ROM 12. Then, in parallel with this playback, the CPU 11 repeats processing of judging whether the user has entered a sleep state based on detection results of the acceleration sensor and the heartbeat sensor. Here, the CPU repeatedly acquires body movement information such as acceleration and angular velocity by the acceleration sensor, repeatedly acquires pulsation information regarding heartbeat by the heartbeat sensor, and repeatedly judges whether or not the movement of the user is equal to or less than a threshold value and the heart rate has decreased below a threshold value (a value of rest), on the basis of body movement information and pulsation information.

Then, when judged that the user has entered a sleep state, that is, when the above-described conditions are satisfied, the CPU 11 ends the playback of the sleep inducing music and records the current time as a sleep onset time. Then, the CPU 11 controls the display screen of the display section 5 such that the start screen G42 is switched to a detection result screen G43 shown in FIG. 9C and thereby displays, on the screen of the display section 5, time information 75 indicating the sleep onset time together with the above-described calendar information 52 and time information 53. Then, the CPU 11 ends the processing started immediately after the first band 3 and the second band 4 are switched to other bands.

In the above-described case where the display items on the initial screen G41 have been changed by the user, the sleeping condition distribution information indicating the distribution of the REM sleep states and the non-REM sleep states measured yesterday during the sleeping hours is displayed on the initial screen G41. In this case, in the sleep inducing processing of Step S23, sleep state estimation processing described below is performed in addition to the above-described processing. Here, for example, a feature amount for each certain time period (such as an average heartbeat interval, a standard deviation, a LF/HF ratio, or the like) is calculated from pulsation information, a feature amount series is generated from the feature amounts acquired in time series, and sleep stages (sleep states) are estimated from a feature amount at each clock time by using a sleep stage probability estimation model learnt in advance. Then, time periods where estimated sleep stages correspond to REM sleep states and time periods where estimated sleep states correspond to non-REM sleep states are recorded as the above-described sleep state distribution information.

By the above-described processing, when the first band 3 and the second band 4 are switched to other bands for a different use, one of the first to fourth functions corresponding to this use is automatically enabled and the other functions are disabled. In addition, timepiece face information on the display section 5 is automatically changed.

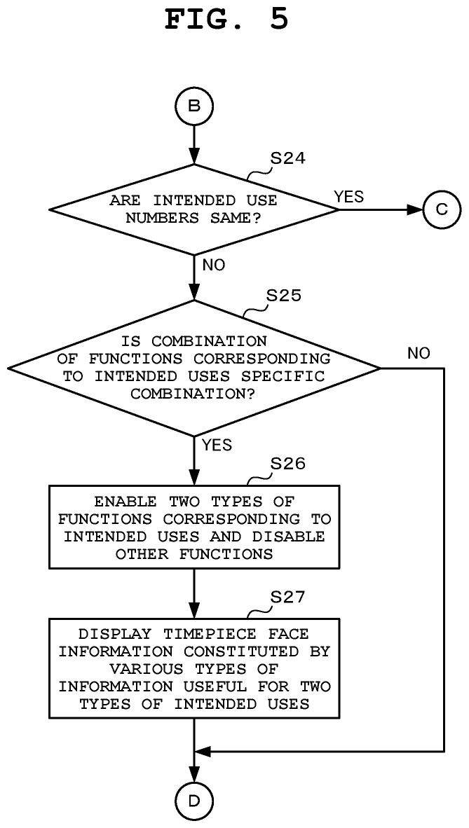

On the other hand, when a judgment result at Step S6 described above is NO and the read identification information is not a single piece of information but two pieces of information, the CPU 11 performs the following processing shown in FIG. 5.

First, the CPU judges whether intended use numbers included in the two pieces of identification information read from the currently attached first and second bands 3 and 4 are the same. Then, when the intended use numbers are the same (YES at Step S24), the CPU proceeds to Step S7 described above, identifies an intended use corresponding to the intended use number, and performs processing in accordance with the identified intended use among the above-described processing at Steps S8 to S23.

Conversely, when the intended use numbers included in the two pieces of identification information read from the currently attached first and second bands 3 and 4 are not the same (NO at Step S24), the CPU first judges whether a combination of functions corresponding to two types of intended uses corresponding to the intended use numbers is a specific combination (Step S25). More specifically, the CPU 11 judges whether or not the combination of the two types of intended uses is an expected combination, that is, a predetermined combination of functions corresponding to intended uses or one of a plurality of predetermined combinations of functions corresponding to intended uses.

Then, when the combination of the two types of functions corresponding to the two types of intended uses is not a specific combination (NO at Step S25), the CPU 11 ends the processing at this point. In this case, the current operation mode is maintained. In addition, the display of timepiece face information corresponding to this operation mode on the display section 5 is maintained. Conversely, when the combination of the two types of functions is a specific combination (YES at Step S25), the CPU 11 enables these two types of functions and disables the other two types of functions (Step S26). For example, in a case where the above-described two types of intended uses are “running” and “business” and the combination of the first function and the fourth function corresponding thereto is a specific function, the CPU 11 enables the first function and the fourth function and disables the second function and the third function. Then, the CPU 11 displays, on the display section 5, an information group based on the two enabled functions, that is, timepiece face information constituted by various types of information useful for the two types of intended uses (Step S27).

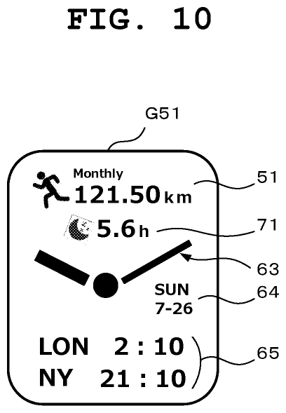

FIG. 10 is a diagram exemplarily showing timepiece face information to be displayed on the display section 5 in such a case. In this example, an initial screen G51 is shown which is displayed on the display section 5 by the processing of Step S27 when two types of intended uses are “running” and “business” and the first function and the fourth function are enabled as with the above-described case. On this initial screen G51, timepiece face information is displayed in a predetermined format, which is constituted by various types of information such as the monthly distance information 51 exemplarily shown in FIG. 6A, the sleeping hours information 71 indicating the amount of time spent sleeping yesterday, and the time information 63, the calendar information 64, and the world time information 65 exemplarily shown in FIG. 8A. After starting such display, the CPU 11 ends the processing started immediately after the first band 3 and the second band 4 are switched to other bands.

In this case where the initial screen G51 exemplarily shown in the drawing has been displayed by the bands for different uses being attached to the device main body 2, the user selects one of the currently enabled two functions, that is, one of the first function and the fourth function by performing a tap operation or a flick operation on the display section 5, whereby the electronic device 1 can be controlled to immediately execute a desired function.

Note that, when one of the initial screens G11, G21, G31, G41, and G51 is being displayed on the display section 5 during the series of processing described above, the CPU 11 may perform the following processing. In this processing, when only a specific function corresponding to the intended use of the current first and second bands 3 and 4 has been enabled and the other functions among the first to fourth functions have been disabled by the previous first and second bands 3 and 4 being switched, that is, when a mode corresponding to the intended use of the current first and second bands 3 and 4 has been fixed as the current operation mode, the CPU judges whether an operation for releasing this state, such as a release operation by holding down the operation switches 6 and 7, has been performed. Then, when a release operation is performed, the CPU performs process of releasing this state. With this configuration, by performing a normal mode selection operation by a tap operation or a flick operation on the display section 5 so as to select an arbitrary mode as the next operation mode, the user can use an arbitrary function among the above-described first to fourth functions. That is, the electronic device 1 can be controlled to execute an arbitrary function.

As described above, the electronic device 1 of the present embodiment is configured such that, when the first band 3 and the second band 4 are switched to other first and second bands 3 and 4, these first and second bands 3 and 4 attached to the device main body 2 are identified, and only a specific function corresponding to the intended use thereof is automatically enabled. That is, among the plurality of functions of the electronic device 1, a specific function corresponding to the currently attached first and second bands 3 and 4 is automatically enabled and the other functions are disabled.

Therefore, the user himself or herself is not required to perform an operation of setting an operation mode according to an intended use. That is, the user is not required to perform an operation of enabling a specific function after switching the first band 3 and the second band 4 to other bands whose intended use is different. As a result of this configuration, the usability of the electronic device 1 is improved. In addition, by the first band 3 and the second band 4 being switched to other bands, unintended functions are prevented from being accidentally executed. For example, when the first band 3 and the second band 4 for business have been attached, the first function useful for a running exercise and the second function that supports the user's sleep are not accidentally executed. This configuration is highly effective because if the first function is accidentally executed, electric power is wastefully consumed by position measurement by the GPS sensor while the user is unaware.

Also, when the first and second bands 3 and 4 whose intended uses are different from each other are attached to the device main body 2 and a combination of two types of functions corresponding to these two types of intended uses is a specific combination, that is, a predetermined combination or one of a plurality of predetermined combinations, the two types of functions are automatically enabled and the other two types of functions are disabled. As a result of this configuration, the usability of the electronic device 1 is further improved.

Moreover, in the present embodiment, after the first band 3 and the second band 4 are switched to other first and second bands 3 and 4 and a specific function (one function) corresponding to the intended use of the attached first and second bands 3 and 4 is enabled, this specific function can be immediately executed by a single operation such as a tap operation or a flick operation on the display section 5. As a result of this configuration, the user can immediately use a specific function corresponding to the intended use of the first and second bands 3 and 4, which further improves the usability of the electronic device 1.

As described above, in the configuration of the present embodiment, a specific function corresponding to the intended use of the first and second bands 3 and 4 is immediately executed by a single operation. However, in the actual implementation of the present invention, the following configuration may be adopted. In this configuration, after the first band 3 and the second band 4 are switched to other bands and a specific function (one function) corresponding to the intended use of these bands is enabled, if there is another function accompanying this specific function, the user can execute this function as necessary. Examples of this another function accompanying the specific function include, when the second function for supporting the user's sleep is the specific function, a function that enables the user to select sleep inducing music to be replayed in the sleep inducing processing. Also, this another function may be a function of setting (changing) display items of the initial screen G11, G21, G31, G41, or G51 to be displayed on the display section 5.

Also, in the present embodiment, the four types of intended uses of the first and second bands 3 and 4 are “running”, “cycling”, “business”, and “sleep”, and the electronic device 1 has the first to fourth functions corresponding to these intended uses. However, in the present invention, the specific contents of the functions corresponding to the intended uses of the first and second bands 3 and 4 are not limited to those described above and may be changed as necessary. For example, in the present embodiment, the specific processing to be performed when the fourth function useful for business is performed is the display processing of timepiece face information including task information regarding the user's tasks and the mindfulness support processing. However, this mindfulness support processing may be eliminated. In addition, the task information may be in-progress project information, information regarding the addresses and phone numbers of clients, or the like inputted and stored in advance in the ROM 12.

Also, in the configuration of the present embodiment, the CPU 11 of the device main body 2 repeatedly performs the processing shown in FIG. 3 to FIG. 5 at operation timings in predetermined cycles, and judges whether the first band 3 and the second band 4 have been switched to other bands by the acceleration sensor. However, this configuration may be changed as needed. For example, a configuration may be adopted in which the device main body 2 is provided with a detection switch that is in an OFF state when the first and second bands 3 and 4 have not been attached and is in an ON state when the first and second bands 3 and 4 have been attached, and the CPU 11 judges whether the first and second bands 3 and 4 have been switched to other bands by using this detection switch.

Alternatively, a structure may be adopted in which whether the first band 3 and the second band 4 have been switched to other bands is not automatically judged (or detected), and the CPU 11 starts performing the processing of Step S2 and the following steps in FIG. 3 when a switch operation for starting the use of the electronic device 1 is performed by the user. Note that the operation for starting the use of the electronic device 1 herein is, for example, a switch operation of turning on the power supply or a switch operation of starting the display operation of the display section 5 (the touch display section 17) when it is in an OFF state.

Also, in the configuration of the present embodiment, the device main body 2 (the CPU 11) identifies the intended use of the first and second bands 3 and 4 based on identification information read from the wireless tags 8 provided therein. However, in the present invention, an arbitrary method may be adopted to identify the intended use of the first and second bands 3 and 4. In other words, any method can be adopted as long as identification information can be provided to the device main body 2 with the first band 3 and the second band 4 being attached to the device main body 2. Thus, in the actual implementation of the present invention, the following configurations can be adopted.

In one configuration example, memories having identification information stored therein and output terminals for reading out the identification information from the memories are provided in the first band 3 and the second band 4 instead of the wireless tags 8, and input terminals with which the output terminals come in contact are provided in the device main body 2. With this configuration, the device main body 2 can directly reads out the identification information from the memories of the first and second bands 3 and 4 so as to identify the intended use of the first and second bands 3 and 4.

In another configuration example, three or more switch terminals are provided on attachment sections of the device main body 2 where the first band 3 and the second band 4 are attached, and connection terminals to which two specific switch terminals of the plural switch terminals are selectively connected (enter conductive states) when the first band 3 and the second band 4 are attached to the device main body 2 are provided on the first and second bands 3 and 4 instead of the wireless tags 8, whereby the intended use of the first and second bands 3 and 4 can be identified on the basis of differences in combinations of connected switch terminals.

Also, in the configuration of the present embodiment, timepiece face information to be displayed on the display section 5 is changed in accordance with the intended use of the attached first and second bands 3 and 4. However, for example, a configuration may be adopted in which timepiece face information to be displayed on the display section 5 is changed in accordance with the color or design of the attached first and second bands 3 and 4. In this configuration, design information indicating colors and designs are stored in the wireless tags 8 of the first and second bands 3 and 4 instead of or in addition to identification information, and the color tone and design of timepiece face information to be displayed on the display section 5 are controlled in accordance with the design information.

Also, the above-described identification information to be provided to the device main body 2 may include, for example, information indicating that the first and second bands 3 and are licensed products (such as encrypted manufacturer information). In this case, a configuration may be adopted in which the device main body 2 (the CPU 11) performs authenticity judgment as to whether bands attached thereto are licensed products on the basis of identification information and, if they are not licensed products, displays a message indicating this judgment on the display section 5, blackens the screen of the display section 5, or restricts functions to be displayed on the display section 5. With this configuration, the user can be notified when bands that are not licensed products are attached to the device main body 2.

Also, in the case of the present embodiment, the two members constituted by the first band 3 and the second band 4 are attached to the device main body 2. However, in the present invention, a structure may be adopted in which a single band is attached to the device main body 2. That is, the present invention is applicable to, for example, an electronic device having a single band of which one end is provided with a buckle and the other end is connected to the buckle and in which an attachment section for attaching the device main body 2 of the electronic device is provided. Note that the structure of the attachment section in that case may be arbitrarily determined. For example, the attachment section may be a recess section or an opening section into which the device main body 2 is fitted.

Also, although the cases have been described in which the present invention is mainly applied in a wristwatch type electronic device, the present invention is not limited thereto, and may be applied in other shaped electronic devices. In addition, the present invention is not necessarily required to be applied in an electronic device that is used singly, and can be applied in an electronic device that functions by being connected to another device wirelessly or in a wired manner or an electronic device that functions by being connected to a network.

In that case, a configuration may be adopted in which, when executing a function corresponding to the intended use of the first and second bands 3 and 4 attached to the device main body 2, the electronic device 1 performs only the acquisition of various types of information necessary for each processing described above, transmits the acquired information to the other device described above, and causes the other device to perform processing on the basis of the transmitted information. In this configuration, for example, when executing the first function useful for a running exercise or the third function useful for a cycling exercise, the electronic device 1 performs processing of acquiring the above-described various types of information such as heart rate, distance, velocity, or the like, that is, exercise information measurement processing for measuring exercise information of the user. Also, for example, when executing the second function for supporting the sleep of the user, the electronic device 1 performs processing of acquiring the above-described body movement information and pulsation information, that is, sleep state measurement processing for measuring the sleep state of the user. In this configuration, the various types of information to be transmitted by the electronic device 1 may be detection results of various sensors of the sensor section 16, that is, primary data, or secondary data acquired (derived) based on those detection results.

As described above, the intended use of the first and second bands 3 and 4 herein may be an exercise other than “running” and “cycling”, that is, various exercises such as swimming, yoga, and other fitness exercises other than a running exercise and a cycling exercise. In that case, functions helpful for these various exercises other than a running exercise and a cycling exercise are provided to the electronic device 1, and the electronic device 1 performs exercise information measurement processing for measuring exercise information related to these exercises. In this case as well, in the electronic device 1, the configuration may be adopted in which the electronic device transmits exercise information acquired in exercise information measurement processing to the other device described above, and causes the other device to perform processing based on the transmitted exercise information. In that case, for example, if a corresponding exercise is swimming, the exercise information includes the number of strokes (the counted number of strokes, the number of strokes per unit distance such as 25 meters in the case of a 25-meter swimming pool, the number of strokes per unit time), time spent swimming, a heart rate during swimming, a calorie consumed by swimming, or the like. Also, for example, if a corresponding exercise is yoga, the exercise information includes time spent on yoga, a heart rate during yoga, a calorie consumed by yoga, or the like.

Also, in the present embodiment, the first band 3 and the second band 4 attached to the wristwatch type electronic device 1 have been exemplarily described as exterior bodies according to the present invention. However, the exterior body of the present invention is not limited thereto, and may be any exterior body as long as it can be attached to an electronic device. In addition, its shape or intended use is also not limited thereto.

While the present invention has been described with reference to the preferred embodiments, it is intended that the invention be not limited by any of the details of the description therein but includes all the embodiments which fall within the scope of the appended claims.

What is claimed is:

1. A control device of an electronic device comprising:
at least one processor which executes a program stored in at least one memory,
wherein the at least one processor identifies which of a plurality of exterior bodies individually formed in advance is an exterior body attached to a main body of the electronic device capable of executing at least a first function and a second function which are not display functions and are different from each other, and
wherein the at least one processor enables at least the first function of the electronic device and disables at least the second function of the electronic device when the identified exterior body is a certain exterior body among the plurality of exterior bodies, and enables at least the second function of the electronic device and disables at least the first function of the electronic device when the identified exterior body is another exterior body different from the certain exterior body among the plurality of exterior bodies.

2. The control device of the electronic device according to claim 1, wherein the at least one processor identifies a type of an intended use of the exterior body.

3. The control device of the electronic device according to claim 1, wherein the first function includes an exercise information measurement function for measuring exercise information of a user of the electronic device, and
wherein the second function includes a sleep state estimation function for estimating a sleep state of the user of the electronic device.

4. The control device of the electronic device according to claim 1, wherein either of the certain exterior body and the other exterior body is a pair of exterior bodies including a first exterior body and a second exterior body.

5. The control device of the electronic device according to claim 4, wherein the electronic device is configured to be capable of executing at least a third function and a fourth function which are not display functions and are different from each other,
wherein the at least one processor identifies whether a combination of the first exterior body and the second exterior body is a first combination or a second combination, and
wherein the at least one processor enables at least the first function and the third function of the electronic device and disables at least the second function when the combination of the first exterior body and the second exterior body is identified as the first combination, and enables at least the second function and the fourth function of the electronic device and disables at least the first function when the combination of the first exterior body and the second exterior body is identified as the second combination different from the first combination.

6. The control device of the electronic device according to claim 4, wherein the electronic device is configured to be capable of executing at least a third function and a fourth function which are not display functions and are different from each other,
wherein the first function includes a first exercise information measurement function for measuring exercise information of a user of the electronic device who is walking or running,
wherein the second function includes a sleep state estimation function for estimating a sleep state of the user of the electronic device,
wherein the third function includes a second exercise information measurement function for measuring exercise information of the user of the electronic device who is riding a bicycle, and
wherein the fourth function includes a task information output function for outputting task information regarding tasks of the user of the electronic device.

7. The control device of the electronic device according to claim 1, wherein the electronic device is a timepiece having a timepiece main body capable of executing at least the first function and the second function and a band serving as the exterior body.

8. A control method for an electronic device, comprising:
identifying which of a plurality of exterior bodies individually formed in advance is an exterior body attached to a main body of the electronic device capable of executing at least a first function and a second function which are not display functions and are different from each other; and
enabling at least the first function of the electronic device and disabling at least the second function of the electronic device when the identified exterior body is a certain exterior body among the plurality of exterior bodies, and enabling at least the second function of the electronic device and disabling at least the first function of the electronic device when the identified exterior body is another exterior body different from the certain exterior body among the plurality of exterior bodies.

9. A non-transitory computer-readable storage medium having stored thereon a control program that is executable by a computer to actualize functions comprising:
identifying which of a plurality of exterior bodies individually formed in advance is an exterior body attached to a main body of an electronic device capable of executing at least a first function and a second function which are not display functions and are different from each other; and
enabling at least the first function of the electronic device and disabling at least the second function of the electronic device when the identified exterior body is a certain exterior body among the plurality of exterior bodies, and enabling at least the second function of the electronic device and disabling at least the first function of the electronic device when the identified exterior body is another exterior body different from the certain exterior body among the plurality of exterior bodies.

10. A timepiece comprising:
a timepiece main body which is capable of executing at least a first function and a second function which are not display functions and are different from each other;
a band which is attached to the timepiece main body; and
at least one processor which executes a program stored in at least one memory,
wherein the at least one processor identifies which of a plurality of bands individually formed in advance is the band attached to the timepiece main body, and
wherein the at least one processor enables at least the first function of the timepiece main body and disables at least the second function of the timepiece main body when the identified band is a certain band among the plurality of bands, and enables at least the second function of the timepiece main body and disables at least the first function of the timepiece main body when the identified band is another band different from the certain band among the plurality of bands.

11. A timepiece main body which is capable of executing at least a first function and a second function which are not display functions and are different from each other and to which a band is attached, comprising:
at least one processor which executes a program stored in at least one memory,
wherein the at least one processor identifies which of a plurality of bands individually formed in advance is the band attached to the timepiece main body, and
wherein the at least one processor enables at least the first function of the timepiece main body and disables at least the second function of the timepiece main body when the identified band is a certain band among the plurality of bands, and enables at least the second function of the timepiece main body and disables at least the first function of the timepiece main body when the identified band is another band different from the certain band among the plurality of bands.

12. A band that is attached to the timepiece main body according to claim 11, comprising:
a wireless tag which provides the timepiece main body with identification information that is used for identification of the band.
